(19) United States
(12) Patent Application Publication
(10) Pub. No.: US 2015/0291784 A1
(43) Pub. Date: Oct. 15, 2015

(54) COMPOSITE MATERIAL CONTAINING RENEWABLE RAW MATERIALS AND METHOD FOR THE PRODUCTION THEREOF

(71) Applicant: MONDI AG, Wien (AT)

(72) Inventors: Walter Ruef, Wolfsberg (AT); Christoph Guntschnig, Eitweg (AT)

(73) Assignee: MONDI AG, Wien (AT)

(21) Appl. No.: 14/437,654

(22) PCT Filed: Oct. 18, 2013
(86) PCT No.: PCT/AT2013/000176

§ 371 Date: Apr. 22, 2015

(30) Foreign Application Priority Data
Oct. 22, 2012 (AT) A 1136/2012

(51) Int. Cl. C08L 23/12

(52) U.S. Cl. CPC C08L 23/12

(57) ABSTRACT

A composite material made of a plastic base material with particles or fibres of renewable raw materials such as wood fibres, abaca, cellulose fibres, regenerated cellulose fibres, hemp fibres or flax fibres embedded therein and optionally a bonding agent, also contains a wetting agent selected from a polyethylene glycol with an average molecular weight of 90 to 40,000 and/or a polyvalent alcohol.

The present invention relates to a composite material made of a plastic base material selected from polypropylene, polylactic acid (PLA), polymethylmetacrylate, ABS polycarbonate, polyoxymethylene (POM), polyethylene, and particles or fibers of renewable raw materials such as abaca, cellulose fibers, pulp fibers, viscose fibers, hemp fibers or flax fibers embedded therein, and optionally a bonding agent, and to a method for producing a composite material, in which natural fibers such as cellulose fibers, regenerated cellulose fibers, pulp fibers, hemp fibers or flax fibers are mixed in a mixing device with a plastic base material selected from polypropylene, polylactic acid (PLA), polyraethylmetacrylate, ABS polycarbonate, polyoxymethylene (POM), polyethylene, and optionally additives, and pressed into a composite material in a molding press or an extruder.

### BACKGROUND OF THE INVENTION

Composite materials or composites comprised of plastics such as polyolefins, polymethylmetacrylate (PMMA), acrylonitrile-butadiene-styrene copolymers (ABS etc.) and containing particles or fibers of renewable raw materials such as pulp, viscose, hemp, wood, flax etc. are used in various applications, such composite materials yet frequently requiring large amounts of bonding agent in order to provide an intimate bond between the particles or fibers of renewable raw materials and the plastics. In this respect, polyolefins, maleic anhydride groups grafted on polypropylene or polyethylene are, for instance, used as bonding agents in order to provide sufficient bonding capacity between the plastics and the particles or fibers of renewable raw materials. Another problem encountered in such composite materials, however, resides in that, once they contain particles or fibers of renewable raw materials, the impact strength or notched impact strength of the products produced thereof will be drastically reduced such that the purpose of use of such materials is limited. Attempts have been made to soften a matrix of plastic and particles or fibers or renewable raw materials by adding softer polymers or polymers having lower molecular weights in order to increase the impact strength, yet this had only limited success, in particular where no soft base polymer has been provided or used from the beginning. In order enable the use of such polymers for applications such as the automotive industry, electric/electronic industry, logistics industry, it is, therefore, necessary to significantly increase the (notched) impact strength of the composites filled with particles or fibers of renewable raw materials or supplemented with particles or fibers of renewable raw materials, without adversely affecting other properties or characteristics at the same time.

From WO 03/035393 A1, a composite made of FVC and wood fibers can be taken, in which additives such as polyester and a lubricant may be additionally contained. The addition of polyvinylchloride (PVC) to the wood fibers is no facilitate the processability of the composite to be produced, since these are to be moldable at low temperatures.

From US 2011028060 A1, composite structures containing a fibrous material and a matrix-resin composition can be taken, which composite structures in addition to a fibrous material contain a matrix-resin composition comprising polyamide compositions. According to that document, the polyamide compositions themselves are composed of a polyamide resin and polyalcohols with more than two hydroxyl groups.

WO 02/083824 A1 describes composite compositions for molded articles, comprising a cellulose fiber, a thermoplastic binder, a coupling agent containing maleic anhydride and maleic anhydride functionalities, and a lubricant containing alkyl esters of a carboxylic acid.

### BRIEF SUMMARY OF THE INVENTION

The present invention, therefore, aims to provide a composite material which, on the one hand, has a (notched) impact strength increased over that of conventional composite materials made of base polymers and additives based on particles or fibers of renewable raw materials and, on the other hand, provides a material bond, and material properties, that are at least as good as those of conventional composite materials.

To solve this object, the composite material according to the invention is essentially characterized in that it further contains a wetting agent, selected from a polyethylene glycol with an average molecular weight of 90 to 40,000 and/or a polyvalent alcohol. By adding a wetting agent, at least the natural fibers are impregnated with the wetting agent so as to enable each fiber in the composite material to be kept wetted or soft, and hence to be softened, which will result in an increased expansion or expandability of the fiber in case of load. An increased expansion or expandability of the fiber will further result in a simultaneously enhanced lubrication and wetting effect on the interface between fiber and plastic, which will consequently lead to an increased (notched) impact strength of the overall composite as compared to conventional composites, in which the fibers are not impregnated.

It has turned out to be advantageous, in particular for composites having to withstand elevated temperatures, if a polyethylene glycol with an average molecular weight of 90 to 40,000 is used. By using polyethylene glycol with an average molecular weight of 90 to 40,000, in particular 120 to 2,000, the lubrication effect on the interface between fiber and plastic will, in particular, be significantly increased, which will also significantly improve the overall impact strength of the composite as compared to conventional composites without addition of low-molecular polyethylene glycols having average molecular weights of 90 to 40,000.

By the term wetting agent, various alcohols, polyvalent alcohols or polyethylene glycol with average molecular weights of 90 to 40,000 are meant in the present context, which attach to the surfaces of the fibers and/or penetrate into the same, thus wetting or moistening the fibers and thereby keeping the fibers in a softer state than in the non-wetted state.

According to a further development of the invention, the composite material is preferably designed such that the polyvalent alcohol used as wetting agent is selected from sorbitol, glycerin, diethylene glycol, ethylene glycol, propylene glycol, butylene glycol, tetramethylene glycol, pentamethylene glycol or propanediol. Polyvalent alcohols from the above-defined group are characterized in that, on the one hand, they are sufficiently poorly volatile so as to safely avoid inadvertent evaporation from the composite material during processing, and hence a disturbance of the internal structure, and, on the other hand, they allow for sufficient wetting or moistening of the fibers so as to achieve the desired effect of retaining the impact strength.

Particularly advantageous results will be achieved with a composite material in which, the wetting agent is contained in amounts ranging from 0.1 wt % to 6 wt % of the overall composite material. When using such amounts, a significant increase in the (notched) impact strength, in particular by up to 150%, will be possible as compared to composite materials containing no wetting agent.

Particularly high (notched) impact strengths will be achieved with composite materials having the following component ratios: 30 to 95 wt % plastic base material, 5 to 70 wt % particles and fibers of renewable raw materials, 0.5 to 21 wt % wetting agent, and up to 20 wt % additives. A composite material containing approximately twice to four times as much plastic base material as particles or fibers of renewable raw materials, and about 1 to 30 %, in particular 10 to 20 wt %, wetting agent, based on the used particles or fibers of renewable raw materials, enable an even further increase of the impact strength of the plastic or composite material filled with particles or fibers of renewable raw materials.

In order to safely prevent mixing and, in particular, inadvertent breaking or detaching of individual materials, or a separation of the base materials contained in the composite, the composite material according to the invention is further developed to the effect that the additives are selected from a bonding agent selected from polypropylene grafted with maleic anhydride, or polyethylene grafted with maleic anhydride, or chemically modified polyolefins. By using bonding agents, it has become possible to produce a composite that withstands even high loads and, in particular, possesses sufficient rigidity in addition to an elevated notched impact strength, without causing any delamination of individual components.

Particularly good results will be achieved according to the invention in that 30 to 95 wt % plastic base material selected from polypropylene, polylactic acid (PLA), polymethylmetacrylate, ABS polycarbonate, polyoxymethylene (POM), polyethylene, 5 to 70 wt % particles or fibers of renewable raw materials selected from cellulose, wood, regenerated cellulose, hemp, flax, 0.5 to 21 wt % wetting agent selected from polyethylene glycol, glycerin, sorbitol, diethylene glycol, 1,3-propandial, and further additives selected from odor absorbers, processing aids, UV stabilizers, coloring agents or bonding agents. When using such a composite material or such composite materials, it will, in particular, be possible to increase the (notched) impact strength by 100% or even more. With the composite materials according to the invention, it has thus become possible to achieve notched impact strengths ranging from 4.5 to 14 kJ/m². Composites having such notched impact strengths can, for instance, be used in the automotive industry, the electric/electronic industry and the logistics industry. With conventional materials, such applications have so far not or only insufficiently been possible because of the low impact strengths.

The invention further aims to provide a method for producing the composite materials according to the invention, which enables in a rapid and reliable manner the production of composite materials containing particles and fibers of renewable raw materials, which stand out for their elevated notched impact strengths as compared to conventional materials.

To solve this object, the method according to the invention is essentially characterized in that the particles or fibers of renewable raw materials are impregnated with a wetting agent. By impregnating the particles or fibers of renewable raw materials with a wetting agent, moistening of the fibers before and during mixing will be enabled, and softening of the fibers will thus be achieved, so as to enable the attainment of an altogether increased expandability of the composite produced with the impregnated particles or fibers of renewable raw materials.

In that, as in correspondence with a preferred further development of the present invention, the method is performed such that the plastic base material is impregnated with the particles or fibers of renewable raw materials and at least a portion of the wetting agent in an internal mixer, it has become possible in a simple and rapid manner to bring into contact, and intimately mix, all components required for the formation of the composite material so as to both ensure sufficient wetting of the particles or fibers of renewable raw materials with the wetting agent and safely prevent demixing, and an inadvertent separation, of the individual components constituting the composite.

In that, as in correspondence with a further development, the method is performed such that the particles or fibers of renewable raw materials are impregnated with a portion of the wetting agent, and the impregnated particles and fibers of renewable raw materials are subsequently mixed in the internal mixer with the plastic base material and the remaining wetting agent, and optionally additives, it has, on the one hand, become possible to ensure that sufficient and uniform wetting of the particles or fibers of renewable raw materials with the wetting agent, and hence moistening and softening of the particles or fibers of renewable raw materials, will be achieved, and it will, on the other hand, be safeguarded, that, all materials will be intimately mixed so as to provide a homogenous and solid composite of ail materials, which after completion will exhibit a significantly increased (notched) impact strength as compared to conventional materials.

Particularly good results and, in particular, a particularly significant increase of the notched impact strength will be achieved if the method according to the invention is performed such that the particles or fibers of renewable raw materials are impregnated with 30 to 60 wt % wetting agent prior to being introduced into the internal mixer. If the particles or fibers of renewable raw materials are impregnated with 30 to 60 wt % of the totally used wetting agent prior to being introduced, into the internal mixer, sufficient moistening of the particles or fibers of renewable raw materials will be ensured while, at the same time, sufficient wetting agent will be available to provide a homogenous material composite.

According to a further development of the invention, the method is performed such that the additives are selected from a bonding agent selected from polypropylene grafted with maleic anhydride, or polyethylene grafted with maleic anhydride, or chemically modified polyolefins.

An even better distribution and, in particular, even more favorable effect will be achieved according to the invention in that the method is performed such that particles or fibers of renewable raw materials discharged, wet from a press are impregnated with wetting agent prior to being charged, into the internal mixer. Such a process control will provide an even more uniform distribution of the wetting agent on the surfaces of the particles or fibers of renewable raw materials, thus allowing for the production of a composite material exhibiting completely homogenous characteristics throughout its volume and over its entire surface.

As in correspondence with a preferred further development of the method according to the invention, the latter is performed such that the material mixture from the internal mixer is supplied to a molding press or an extruder and pressed at a pressure elevated relative to atmospheric pressure, in particular 5 to 40 bar, so as to not only enable the attainment of products exhibiting completely homogenous properties but, in particular, also allow for the manufacture of a variety of desired shapes and articles with the composite according to the invention.

### BRIEF DESCRIPTION OF THE SEVERAL VIEWS OF THE DRAWING(S)

In the following, the invention will be explained in more detail by way of exemplary embodiments or Figures. Therein,

FIG. 1 is a diagram indicating the change of the notched impact strength by the addition of different wetting agents;

FIG. 2 is a block diagram indicating the change of the notched. impact strength upon addition of different wetting agents; and

FIG. 3 compares the influences of different process controls on the notched impact strength of an end product.

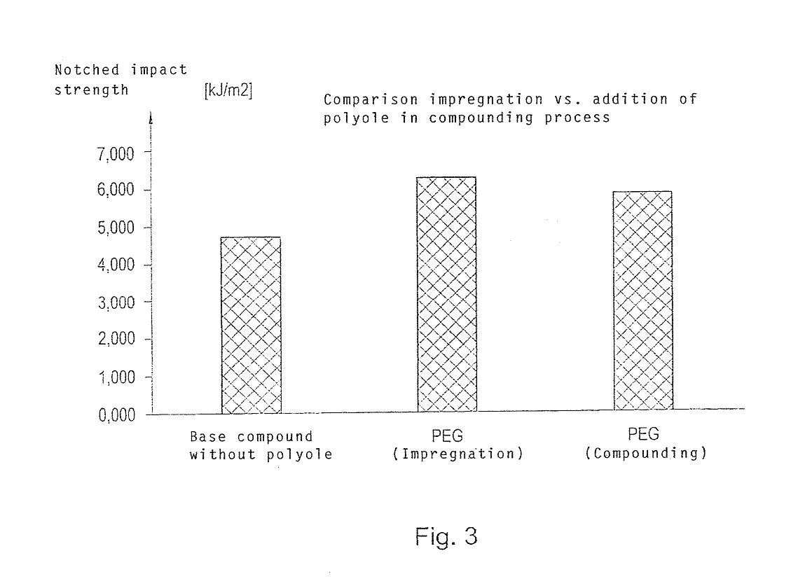

### DETAILED DESCRIPTION OF THE INVENTION

### Example 1

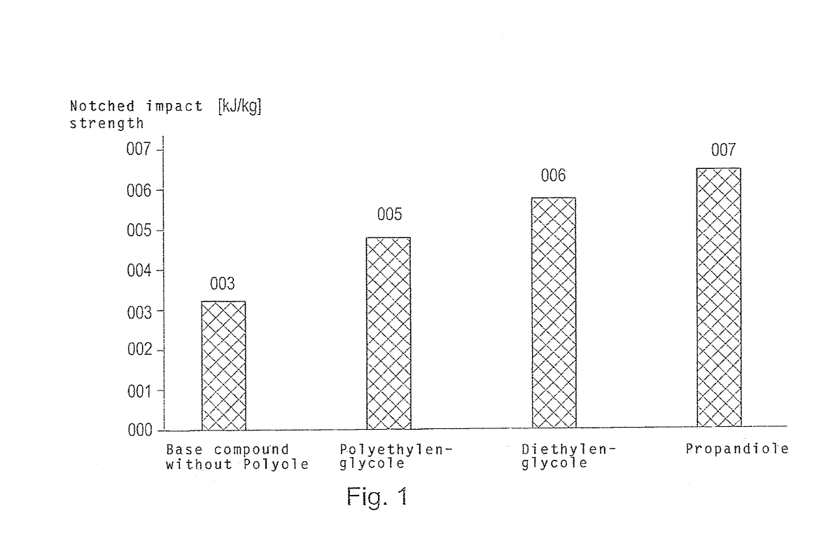

To produce a composite according to the invention, the starting substances of a. composite material, i.e. 80 wt % polypropylene and 20 wt % cellulose fibers, are kneaded in an internal mixer at 180° C. for 4 minutes and pressed info a composite. The notched impact strength of the thus produced composite was determined to be 3.27 kJ/m². The starting material was subsequently changed by replacing 2 wt % of the polypropylene with a wetting agent and producing composites using the same process control. When adding 2 wt % of polyethylene glycol, the notched impact strength can be increased to 4.77 kJ/m², after the addition of 2 wt % diethylene glycol, the notched, impact strength is increased to 5.79 kJ/m², and when adding propanediol, the notched impact strength can be raised to 6.51 kJ/m², as can be taken from annexed FIG. 1.

### Example 2

The mode of procedure of Example 1 is repeated with the exception that the amount of the employed wetting agent is varied in order to be able to recognize the influence of the amount of wetting agent on the notched impact strength.

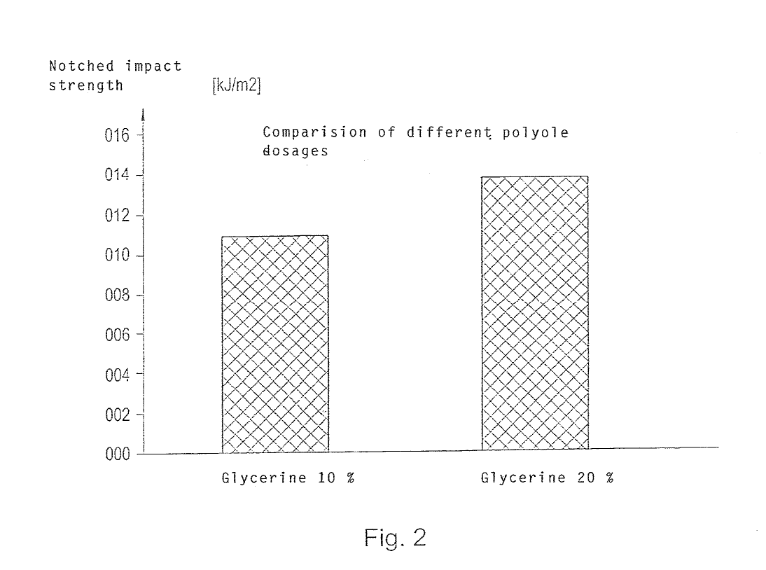

Into the starting material of Example 1 was mixed 2 wt % glycerol as wetting agent, whereupon a notched, impact strength of 10.55 kJ/m² was achieved. When adding 4 wt % of glycerol to the same starting mixture, an increase in the notched impact strength to 13.82 kJ/m² will result, as can be taken from FIG. 2. From this comparison, it can be seen that an increase in the amount of addition will also increase the notched impact strength.

### Example 3

A base composite material as described in Example 1 was produced without any wetting agent added. The thus produced base composite material was compared to a composite material containing 20% fiber portion and 2% wetting agent, wherein the process control was once selected as described in Example 1, by which method a notched impact strength of 5.85 kJ/m² was obtained, as compared to a notched impact strength of 4.75 kJ/m² with a composite material having no wetting agent added. The wetting agent was a polyethylene glycol with an average molecular weight of 150.

In another process control, the polyethylene glycol was finally used to impregnate the cellulose fibers prior to their introduction into the internal mixer, and the thus impregnated cellulose fibers were subsequently charged into the internal mixer and mixed with the plastic base material as described in Example 1, and pressed into a composite. A composite produced in this manner, as compared to the production method described in FIG. 1, exhibited a notched impact strength of 6.23 kJ/m² as compared to 5.85 kJ/m² by the process control of Example 1. It is apparent from these results that the notched impact strength can be further increased as a function of the selected process control.

In Examples 4 to 8, the process control of Example 1 was retained and the development of the notched impact strengths of composite materials was investigated using different particles or fibers of renewable raw materials and different wetting agents.

As in the preceding Examples, notched impact strength values were measured at 23° C.

### Example 4

A composite material of 45 wt % polypropylene, 50 wt % wood fibers and 5 wt % polyethylene glycol was processed to a composite as described, in Example 1. The notched impact strength measured at room temperature (23° C.) was 6.46 kJ/m² with the composition used in Example 4 as opposed to 3.4 kJ/m² with a comparable composite material having no wetting agent, i.e. polyethylene glycol, added.

### Example 5

A composite material of 67 wt % polypropylene, 30 wt % hemp fibers and 3 wt % propanediol was processed to a composite as described in Example 1. The notched impact strength measured at room temperature (23° C.) was 5.5 kJ/m² with the composition used in Example 5 as opposed to 2.2 kJ/m² with a comparable composite material having no wetting agent, i.e. propanediol, added.

### Example 6

A composite material of 67 wt % polypropylene, 30 wt % rice shells and 3 wt % glycerol was processed to a composite as described in Example 1. The notched impact strength measured at room temperature (23° C.) was 3.2 kJ/m² with the composition used in example 6 as opposed to 2.1 kJ/m² with a comparable composite material having no wetting agent, i.e. glycerol, added.

### Example 7

A composite material of 67 wt % polypropylene, 30 wt % flax fibers and 3 wt % glycerol was processed to a composite as described in Example 1. The notched impact strength measured at room temperature (23° C.) was 6.1 kJ/m² with the composition used in Example 7 as opposed to 3.2 kJ/m² with a comparable composite material having no wetting agent, i.e. glycerol, added.

### Example 8

A composite material of 67 wt % polypropylene, 30 wt % viscose fibers and 3 wt % polyethylene glycol was processed to a composite as described in Example 1. The notched impact strength measured at room temperature (23° C.) was 6.2 kJ/m² with the composition used in Example 8 as opposed to 4 kJ/m² with a comparable composite material having no wetting agent, i.e. polyethylene glycol, added.

1. A composite material made of a plastic base material selected from polypropylene, polylactic acid (PLA), polymethylmetacrylate, ABS polycarbonate, polyoxymethylene (POM), polyethylene, and particles or fibers of renewable raw materials such as wood fibers, abaca, cellulose fibers, pulp fibers, regenerated cellulose fibers, hemp fibers or flax fibers embedded therein, and optionally a bonding agent, wherein it further contains a wetting agent selected, from a polyethylene glycol with an average molecular weight of 90 to 40,000 and/or a polyvalent alcohol.

2. The composite material according to claim 1, wherein the polyvalent alcohol is selected from sorbitol, glycerin, diethylene glycol, ethylene glycol, propylene glycol, butylene glycol, tetramethylene glycol, pentamethylene glycol or propanediol.

3. The composite material according to claim 1, wherein 0.1 wt % to 21 wt % wetting agent are contained.

4. The composite material according to claim 1, wherein it comprises 30 to 95 wt % plastic base material, 5 to 70 wt % particles and fibers of renewable raw materials, 0.5 to 21 wt % wetting agent, and up to 20 wt % additives.

5. The composite material according to claim 1 wherein the additives are selected from a bonding agent selected from polypropylene grafted with maleic anhydride, or polyethylene grafted with maleic anhydride, or chemically modified polyolefins.

6. The composite material according to claim 1, wherein the composite material has a notched impact strength of 2 to 30 kJ/m².

7. The composite material according to claim 1 wherein the wetting agent is contained in an amount of 1 to 30 wt %, in particular 10 to 20 wt %, based on the amount of particles or fibers of renewable raw materials.

8. A method for producing a composite material, in which embedded particles or fibers of renewable raw materials selected from wood fibers, abaca, cellulose fibers, pulp fibers, regenerated cellulose fibers, hemp fibers or flax fibers are mixed in a mixing device with a plastic base material selected from polypropylene, polylactic acid (PLA), polymethylmetacrylate, ABS polycarbonate, polyoxymethylene (POM), polyethylene, and optionally additives, and pressed into a composite material in a molding press or an extruder, wherein at least the particles or fibers of renewable raw materials are impregnated with a wetting agent.

9. The method according to claim 8, wherein the plastic base material is impregnated with the particles or fibers of renewable raw materials and at least a portion of the wetting agent in an internal mixer.

10. The method according to claim 8, wherein the particles or fibers of renewable raw materials are impregnated with a portion of the wetting agent, and that the impregnated particles or fibers of renewable raw materials are mixed in the internal mixer with the plastic base material and the remaining wetting agent, and optionally additives.

11. The method according to claim 8, wherein the particles or fibers of renewable raw materials are impregnated with 0.5 to 30 wt % wetting agent prior to being introduced into the internal mixer.

12. The method according to claim 8, wherein wet cellulose fibers discharged wet from a press are impregnated with, wetting agent.

13. The method according to claim 8 wherein the material mixture from the internal mixer is supplied to a molding press or an extruder and pressed.

14. The method according to claim 8 wherein the additives are selected from a bonding agent selected from polypropylene grafted with maleic anhydride, or polyethylene grafted with maleic anhydride, or chemically modified polyolefins.
